(19) United States
(12) Patent Application Publication
(10) Pub. No.: US 2014/0363643 A1
(43) Pub. Date: Dec. 11, 2014

(54) Surface-Selective Carbon Nanotube Deposition Via Polymer-Mediated Assembly

(71) Applicant: INTERNATIONAL BUSINESS MACHINES CORPORATION, Armonk, NY (US)

(72) Inventors: Ali Afzali-Ardakani, Ossining, NY (US); Jose M. Lobez Comeras, New York, NY (US)

(21) Appl. No.: 13/912,403

(22) Filed: Jun. 7, 2013

(51) Int. Cl. B05D 3/00

(52) U.S. Cl. CPC B05D 3/005; Y10S 977/847; Y10S 977/892; B82Y 40/00
USPC 428/210; 427/472; 428/195.1; 977/847; 977/892

(57) ABSTRACT

Techniques for carbon nanotube (CNT) solubilization and surface-selective deposition via polymer-mediated assembly are provided. In one aspect, a method for self-assembly of carbon nanotubes on a substrate is provided. The method includes the following steps. A charge is created on one or more surfaces of the substrate. The substrate is contacted with carbon nanotube-polymer assemblies dispersed in a solvent, wherein the carbon nanotube-polymer assemblies include the carbon nanotubes wrapped in a polymer having side chains with charged functional groups, and wherein by way of the contacting step the carbon nanotube-polymer assemblies selectively bind to the charged surfaces of the substrate based on complementary electrostatic interactions between the charged functional groups on the polymer and the charged surfaces of the substrate and thereby self-assemble on the substrate. A resulting structure is also provided.

### FIELD OF THE INVENTION

The present invention relates to carbon nanotube (CNT) deposition processes and more particularly, to techniques for CNT solubilization and surface-selective deposition via polymer-mediated assembly.

### BACKGROUND OF THE INVENTION

Carbon nanotubes (CNTs) are promising candidates for many different applications such as sensors, supercapacitors, electrodes, drug-delivery, and digital logic. However, one factor limiting the widespread application of CNTs is that many of these applications would require the selective deposition of CNTs from solution onto specific areas of a substrate without covering the whole substrate with a blanket film of CNTs. The selective deposition of CNTs has been difficult, due to: (1) the low solubility of CNTs in most solvents; (2) the difficulty of adapting traditional solution-based processes for the fabrication of CNT thin films; and (3) the lack of proper techniques capable of yielding high-density deposition of CNTs with high selectivity for certain areas of a substrate.

One possible approach for the controlled deposition of CNTs is to use directed self-assembly (DSA), which is an interesting strategy for the fabrication of artificial supramolecular structures or for the modification of surfaces. DSA has been reported using building blocks as diverse as DNA or nanoparticles.

Even though there are a number of examples for the DSA of CNTs with high surface selectivity, these methods have one or several of the following drawbacks: (1) they require covalent chemical modifications that can affect (and damage) the optical and electronic properties of the CNTs; (2) the CNT deposition yield is low and the films have a very low density of CNTs; (3) current methods rely on the use of surfactants which have weak hydrophobic interactions with the CNTs, and the presence of free surfactant affects the DSA process, lowering the yield of CNT deposition.

For example, H. Park et al., “High-density integration of carbon nanotubes via chemical self-assembly,” Nature Nanotechnology 7, 787-791 (October 2012) (hereinafter “Park”), the contents of which are incorporated by reference herein, describes solubilization of CNTs in water using sodium dodecyl sulfate (SDS) as a surfactant. See also, U.S. Patent Application Publication Number 2013/0082233 A1, filed by Afzali-Ardakani et al., entitled “Selective Placement of Carbon Nanotubes Via Coulombic Attraction of Oppositely Charged Carbon Nanotubes and Self-Assembled Monolayers” (hereinafter “U.S. Patent Application Publication Number 2013/0082233”) the contents of which are incorporated by reference herein.

While the SDS surfactant-based approach is effective in a variety of applications, there are some notable drawbacks to the process. First, the interaction between the SDS and the CNTs is relatively weak, which means that there is a dynamic equilibrium between the surfactant molecules on the CNT surface and the free SDS surfactant in solution. The exact amount of free SDS is dependent on the deposition conditions (concentration, temperature . . . ) and thus can cause irreproducibility in the deposition process. Second, since free SDS will be competing with the SDS-coated CNTs for deposition on the positively charged surface, the presence of free SDS surfactant can lower the yield of CNT deposition. Third, excess surfactant is hard to detect with traditional chemical analysis methods based on electrical and spectroscopic measurements. Fourth, in order to remove the maximum amount of free surfactant possible before CNT deposition, a dialysis is usually required, which is an additional processing step, and which also has the setback of being time/concentration dependent (potentially causing irreproducibility problems from batch to batch). Fifth, removal of excess surfactant usually leads to CNT aggregation, which can cause a decrease in the deposition yield of individual tubes. Sixth, in order to decrease CNT deposition times, and so that reservoir solutions of CNT/surfactant can be used several times for CNT deposition, it is desirable to have CNT solutions with a relatively high concentration. However, high concentrations of CNTs cannot be achieved without using an excess of SDS surfactant, which is detrimental for deposition purposes. Seventh, since the surfactant is not very strongly bound to the surface of the CNTs, the amount of free surfactant can vary over time, which ultimately leads to irreproducibility as well.

Accordingly, improved CNT solubilization and surface-selective deposition techniques that can be used for the reproducible fabrication of homogeneous thin films of CNTs from solution, while coating only specific areas of a substrate would be desirable.

### SUMMARY OF THE INVENTION

The present invention provides techniques for carbon nanotube (CNT) solubilization and surface-selective deposition via polymer-mediated assembly. In one aspect of the invention, a method for self-assembly of carbon nanotubes on a substrate is provided. The method includes the following steps. A charge is created on one or more surfaces of the substrate. The substrate is contacted with carbon nanotube-polymer assemblies dispersed in a solvent, wherein the carbon nanotube-polymer assemblies include the carbon nanotubes wrapped in a polymer having side chains with charged functional groups, and wherein by way of the contacting step the carbon nanotube-polymer assemblies selectively bind to the charged surfaces of the substrate based on complementary electrostatic interactions between the charged functional groups on the polymer and the charged surfaces of the substrate and thereby self-assemble on the substrate.

In another aspect of the invention, a structure is provided including: carbon nanotubes on a substrate, wherein the substrate includes one or more charged surfaces and wherein the carbon nanotubes are wrapped in a polymer so as to form carbon nanotube-polymer assemblies, the polymer having side chains with charged functional groups, and wherein the carbon nanotube-polymer assemblies are selectively bound to the charged surfaces of the substrate based on complementary electrostatic interactions between the charged functional groups on the polymer and the charged surfaces of the substrate.

A more complete understanding of the present invention, as well as further features and advantages of the present invention, will be obtained by reference to the following detailed description and drawings.

### BRIEF DESCRIPTION OF THE DRAWINGS

FIG. 1 is a schematic diagram illustrating the present polymer-mediated directed self-assembly process according to an embodiment of the present invention;

FIG. 2 is a diagram illustrating a regioregular polythiophene polymer with charged phosphonate side-chains according to an embodiment of the present invention;

FIG. 3 is a diagram illustrating synthesis of poly(thiophene)s with functional side-chains bearing negatively charged functional groups from a parent poly(thiophene) polymer with alkylbromide side-chains according to an embodiment of the present invention;

FIG. 4 is a diagram illustrating an exemplary methodology for self-assembly of carbon nanotubes (CNTs) on a substrate using surface-selective deposition of the CNTs via polymer-mediated assembly according to an embodiment of the present invention;

FIG. 5 is a schematic diagram illustrating selective interaction of the CNT/polymer assemblies with the charged (metal-oxide) surfaces of a substrate according to an embodiment of the present invention;

FIG. 6 is a scanning electron micrograph (SEM) image of a patterned substrate of hafnium oxide (HfO₂) on silicon dioxide (SiO₂) after (polymer-mediated) directed self-assembly of carbon nanotube (CNT)/polymer assemblies according to an embodiment of the present invention;

FIG. 7 is a magnified view of the image of FIG. 6 showing how the HfO₂ areas of the substrate are covered with CNTs according to an embodiment of the present invention;

FIG. 8 is a magnified view of the image of FIG. 6 showing how CNTs are not present on the SiO₂ areas of the substrate according to an embodiment of the present invention;

FIG. 9 is an SEM image showing the deposition of the present CNT/polymer assemblies on HfO₂/SiO₂ patterned substrates where no monolayer treatment has been applied according to an embodiment of the present invention;

FIG. 10 is an SEM image showing the deposition of CNT/P3HT on HfO₂/SiO₂ patterned substrates according to an embodiment of the present invention;

FIG. 11 is an SEM image showing the deposition of the present CNT/polymer assemblies on HfO₂/SiO₂ patterned substrates, where the polymer has a 5% content of phosphonic acids in the side-chain according to an embodiment of the present invention;

FIG. 12 is an SEM image showing the deposition of the present CNT/polymer assemblies on HfO₂/SiO₂ patterned substrates, where the polymer has 50% content of phosphonic acids in the side-chain according to an embodiment of the present invention;

FIG. 13 is a diagram illustrating an exemplary process for the synthesis of poly(thiophene)s with alkylbromide side-chains according to an embodiment of the present invention; and

FIG. 14 is a diagram illustrating an exemplary process for polymer side chain modification to obtain phosphonated polythiophenes according to an embodiment of the present invention.

### DETAILED DESCRIPTION OF PREFERRED EMBODIMENTS

Provided herein are techniques for the selective deposition of thin films of carbon nanotubes (CNTs) on specific surfaces using polymer-mediated directed self-assembly. With the present techniques, a combination of CNT/polymers can be used for CNT deposition and further device fabrication. The polymers have a backbone capable of binding strongly to the surface of the CNTs. These polymers have side-chains with charged functional groups capable of solubilizing the CNTs via interaction with the solvent and these same functional groups can also be used for the selective deposition of CNTs on specific areas of a given substrate. The interactions responsible for this selectivity are complementary electrostatic interactions between the functional groups and those areas of the substrate. See FIG. 1.

FIG. 1 is a schematic diagram illustrating the present polymer-mediated directed self-assembly process. As shown in FIG. 1, in this example, the polymer-mediated assembly employs polymers with charged side chains. For instance as shown in FIG. 1, the present polymer 102 is a functional polymer having (e.g., negatively) charged side chains 104a and a backbone 104b capable of wrapping around CNTs 106 to form CNT/polymer assemblies 108.

A substrate 110 is provided having specific areas 112 having a (e.g., positive) surface charge complementary to the charged side chains 104a on the polymer 102. Thus, once the CNT/polymer assemblies 108 are deposited onto the specific areas 112 of the substrate 110, the CNT/polymer assemblies 108 will self-assemble on the substrate (mediated by the polymer)—thus leading to selective deposition of the CNTs on only desired portions of the substrate.

As will be described in detail below, these functional polymers are used to disperse the CNTs, and modular modifications on the chemical structure of the polymer's side-chain have a large impact on the surface properties of the polymer-coated CNTs. These slight chemical modifications highly influence CNT solubility and enable surface-selective CNT deposition from solution using directed self-assembly based on electrostatic interactions involving the functional groups on the side-chain of the polymer, e.g., poly(thiophene)s with functional side-chains bearing negatively charged functional groups.

As shown in FIG. 1, the functionalized polymer can then be removed if so desired using thermal annealing, effectively leaving behind only the CNTs on the desired parts of the substrate. For example, if the substrate with the assembled CNTs is heated to a temperature of about 400° C., the polymer degrades into volatile organic molecules, leaving only the CNTs behind without disrupting the optical and electronic properties of the CNTs. Regular CMOS fabrication steps can then follow to complete device fabrication.

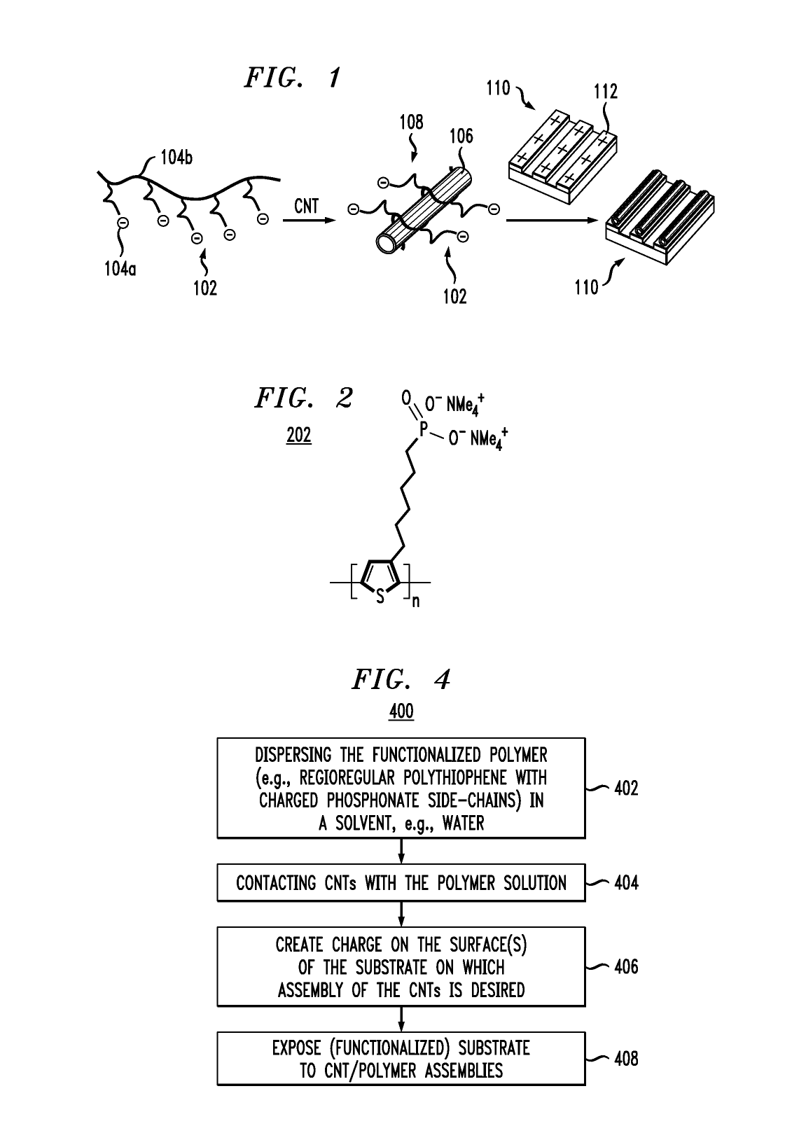

According to an exemplary embodiment, the functional polymers are regioregular polythiophene 202 with charged phosphonate side-chains. See FIG. 2. The backbone of poly(thiophene)s can wrap around the surface of CNTs via pi-pi stacking by way of the extended aromatic system of thiophene rings, effectively decorating the CNT surface with the functional groups on the poly(thiophene) side-chain without disrupting the optical and electronic properties of the CNTs. For a description of pi-pi stacking see, for example, Gu et al., “Fabrication of Free-standing, Conductive, and Transparent Carbon Nanotube Films,” Adv. Mater., 20, 4433-4437 (October 2008), the entire contents of which are incorporated by reference herein.

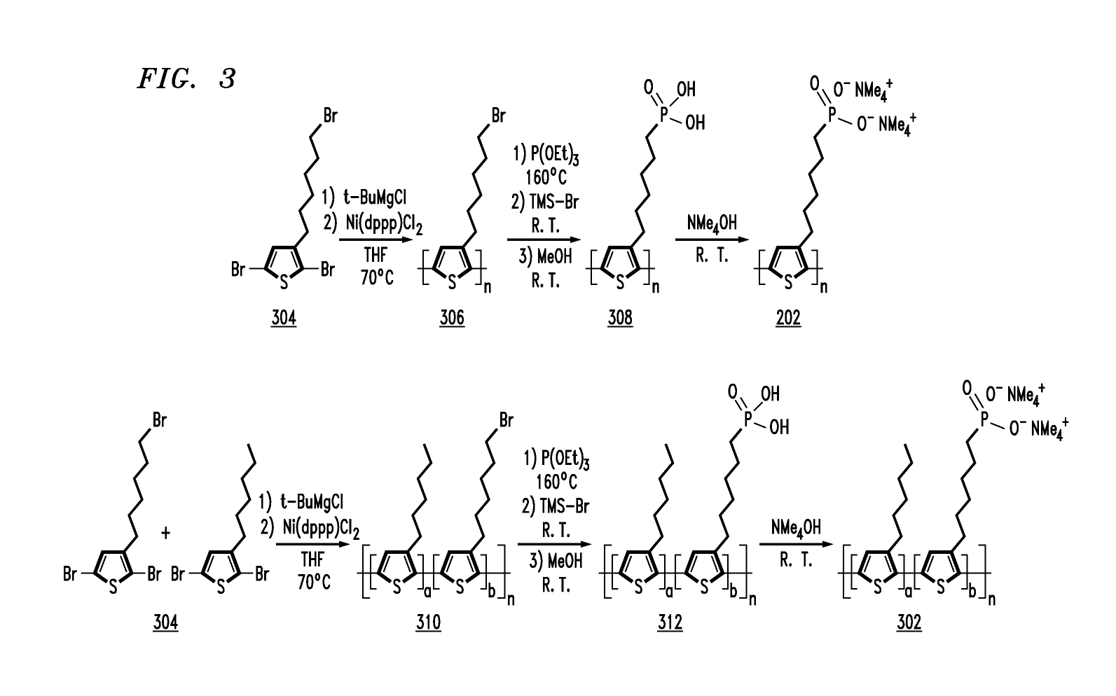

In one exemplary implementation of the present techniques, poly(thiophene)s 202 with functional side-chains bearing negatively charged functional groups were synthesized from a parent poly(thiophene) polymer 306 with alkylbromide side-chains. See FIG. 3. As shown in FIG. 3, this parent poly(thiophene) polymer 306 was synthesized from the corresponding 2,5-dibromo-3-(6-bromohexyl)thiophene monomer 304 using Grignard metathesis (GRIM) polymerization for the synthesis of substituted regioregular poly(thiophene)s. See, for example, R. D. McCullough et al., “Enhanced electrical conductivity in regioselectively synthesized poly(3-alkylthiophenes),” J. Chem. Soc., Chem. Commun., 70-72 (January 1992); R. S. Loewe et al., “A Simple Method to Prepare Head-to-Tail Coupled, Regioregular Poly(3-alkylthiophenes) Using Grignard Metathesis,” Adv. Mater., 11, 250-253 (March 1999); R. S. Loewe et al., “Regioregular, Head-to-Tail Coupled Poly(3-alkylthiophenes) Made Easy by the GRIM Method: Investigation of the Reaction and the Origin of Regioselectivity,” Macromolecules, 34, 4324-4333 (May 2001); J. M. Lobez et al., “Improving the Performance of P3HT-Fullerene Solar Cells with Side-Chain-Functionalized Poly(thiophene) Additives: A New Paradigm for Polymer Design,” ACS Nano, 6, 3044-3056 (February 2012). The entire contents of each of the foregoing references are incorporated by reference herein.

The desired functional groups were incorporated by post-polymerization modifications using a nucleophilic substitution reaction, which is a modular approach for introducing a wide variety of chemical moieties into the side-chains of conjugated polymers. See L. Zhai et al., “A Simple Method to Generate Side-Chain Derivatives of Regioregular Polythiophene via the GRIM Metathesis and Post-polymerization Functionalization,” Macromolecules, 2003 36, 61-64 (Published December 2002), the entire contents of which are incorporated by reference herein. In order to obtain water-soluble, negatively-charged poly(thiophene) 202 to enable DSA of CNTs using electrostatic interactions, the bromide-substituted poly(thiophene) 306 was subjected to a nucleophilic substitution reaction using triethylphosphite followed by phosphonic ester hydrolysis and deprotonation with a tetraalkylammonium hydroxide salt.

In order to study the effect of the degree of side-chain substitution for polymer 202 on the self-assembly of CNTs, random regioregular polythiophenes with different degrees of side-chain functionalization were synthesized using GRIM polymerization conditions using a mixture of 2,5-dibromo-3-hexylthiophene 304 and 2,5-dibromo-3-(6-bromohexyl)thiophene monomers. Treatment of the resulting copolymer 310 with triethyl phosphite followed by ester hydrolysis yielded the corresponding copolymer 312 with different degrees of phosphonic acid functionalization in the side chain. The resulting degree of side-chain functionalization was determined by the initial feed ratio of the monomers. Copolymers 302 where 5% and 50% of the repeat unit side-chain was substituted were thus obtained.

FIG. 4 is a diagram illustrating an exemplary methodology 400 for self-assembly of CNTs on a substrate using surface-selective deposition of CNTs via polymer-mediated assembly. In step 402, the above-described functionalized polymer (e.g., regioregular polythiophene with charged phosphonate side-chains synthesized as described above) is dispersed in a solvent. Suitable solvents include, but are not limited to, water, ethanol, isopropanol, and dimethylsulfoxide. Sonication may be used to help in the dispersion.

Next, in step 404, CNTs (e.g., single-walled carbon nanotubes (SWCNTs) are contacted with the polymer dispersion (from step 402). For example, the CNTs can be added to the polymer dispersion and sonication used to aid in mixing. As described above, the present functional polymers have charged side chains and a backbone capable of wrapping around CNTs to form CNT/polymer assemblies. Thus these CNT/polymer assemblies are formed in step 404, dispersed in the solvent.

According to an exemplary implementation of the present techniques, once mixed, centrifugation was used to remove insoluble CNT bundles, and excess polymer in the supernatant was removed by filtration of the CNT dispersion through a 0.22 micrometer cellulose acetate filter and washing with excess water. Excess polymer in the filtrate solution can be easily detected by UV-Vis spectroscopy. The CNT/polymer assemblies in the filter were resonicated in water and the resulting aqueous dispersion was stable over time. Concentrations of up to several mg/ml of SWCNTs in water could be obtained this way.

As provided above, a goal of the present process is the surface-selective, polymer-mediated assembly of the CNTs on the surface of a given substrate. This is based on the presence of complementary charges on the functionalized polymer and on the substrate. Thus, in step 406, a surface charge is created on those surfaces of the substrate on which assembly of the CNTs is desired. It is notable that while in the instant example surface-selective deposition is employed to deposit CNTs on certain areas of the substrate, if so desired the same processes described herein can be employed to deposit CNTs on the entire surface of a substrate. According to an exemplary embodiment, when the CNT/polymer assemblies contain negatively charged side chains, the substrate can be selectively coated with a monolayer of positively charged molecules. It is notable that the steps of methodology 400 do not need to be performed in the order depicted in FIG. 4. For instance, processing of the substrate may be performed prior to, or concurrently with, the CNT and polymer preparations.

In one exemplary embodiment, the surface charge is selectively created on one or more surfaces of the substrate by forming a monolayer of a compound bearing a (positive or negative) charge on those surfaces. Further, the present techniques can leverage the fact that certain compounds, such as hydroxamic acid, selectively interact with certain metal oxides or other materials (silicon nitride, aluminum oxide) over silicon dioxide. See, for example, J. P. Folkers et al., “Self-assembled monolayers of long-chain hydroxamic acids on the native oxides of metals,” Langmuir, 11, 813-824 (March 1995) (hereinafter “Folkers”), and H. Park et al., “High-density integration of carbon nanotubes via chemical self-assembly,” Nature Nanotech., 7, 787-791 (December 2012). The entire contents of each of the foregoing references are incorporated by reference herein. See also, U.S. Patent Application Publication Number 2013/0082233 which describes an exemplary process for decorating a surface of a substrate with a charge. In one exemplary embodiment, the monolayer includes a positively charged pyridinium salt bearing a hydroxamic acid moiety, NMPI (4-(Nhydroxycarboxamido)-1-methylpyridinium iodide).

Hydroxamic acids and phosphonic acids selectively bind to surfaces which are relatively basic, but they do not bind to surfaces which are more acidic. This can be thought of as an acid/base reaction. For instance, hafnium oxide (HfO₂) is relatively basic, so hydroxamic/phosphonic acid binds to it, and silicon dioxide is relatively acidic, so hydroxamic/phosphonic acid does not bind to it. Other examples of surfaces to which hydroxamic acids and phosphonic acids bind (selectively over binding to silicon dioxide) are silicon nitride and aluminum oxide.

It is believed that surfaces with an isoelectric point greater than the pKa of the acid (hydroxamic, phosphonic) used for the self-assembly will give better directed self-assembly in general, due to deprotonation of the acid. See, for example, Folkers. This is true for silicon nitride, aluminum oxide, hafnium oxide. Conversely, surfaces with an isoelectric point less than the pKa of the acid (hydroxamic, phosphonic) used for the self-assembly will give worse/no directed self-assembly. This is true for silicon dioxide.

Thus, in general, according to the present techniques—those surfaces for which self-assembly of the monolayer is desired will be formed from a material having an isoelectric point greater than the pKa of the acid (hydroxamic, phosphonic) used for the self-assembly, and those surfaces for which self-assembly of the monolayer is not desired will be formed from a material having an isoelectric point that is less than the pKa of the acid. Non-limiting examples include hafnium oxide and silicon dioxide, respectively.

Thus, when hydroxamic acid is used for the self-assembly, the starting wafer can be, for example, a semiconductor wafer having a layer of a first material with an isoelectric point that is less than the pKa of hydroxamic acid, such as SiO₂. A patterned layer of a second material with an isoelectric point that is greater than the pKa of hydroxamic acid, such as silicon nitride, HfO₂ and/or aluminum oxide (Al₂O₃), can be formed on the first material using conventional lithography and etching techniques. As noted above, it may be instead desired to cover the entire surface of the substrate (as opposed to selective areas) with the CNTs, in which case, the whole surface of the substrate would be decorated with the second material. Basically, the second material should be present anywhere on the substrate where deposition of the CNTs is desired.

Namely, the pattern of the second material will dictate where on the surface of the wafer the CNTs will be present since, 1) the charged monolayer will interact with the second material (and not the first material) on the wafer, and 2) the CNT/polymer assemblies will self-assemble on the monolayer based on coulombic attraction between the complementary surface charges of the CNT/polymer assemblies and the charged monolayer. In this example, according to step 406, the surface charge can be selectively created on the (second material) surfaces of the substrate by contacting the substrate with hydroxamic acid (e.g., immersing the substrate in a hydroxamic acid solution or drop casting the hydroxamic acid on the substrate) which will form the charged monolayer on the (second material) surfaces.

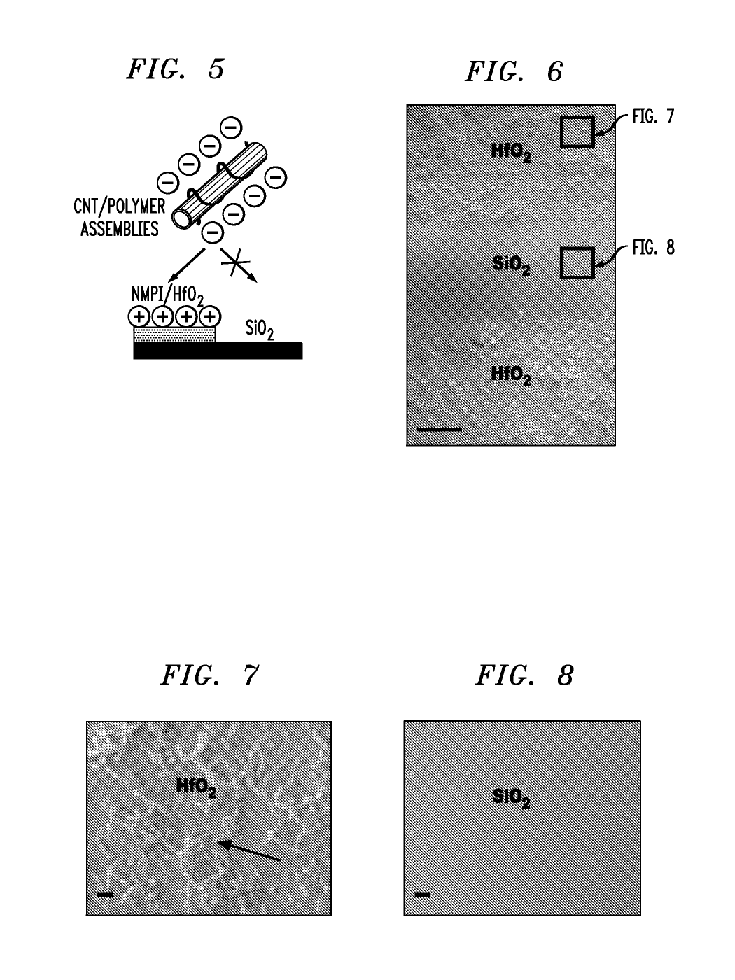

See, for example, FIG. 5 which is a schematic diagram illustrating this selective interaction of the CNT/polymer assemblies with the charged surfaces of a substrate. The example shown in FIG. 5 is that of a SiO₂/HfO₂ patterned wafer, wherein exposure to a positively charged pyridinium salt bearing a hydroxamic acid moiety, NMPI (4-(Nhydroxycarboxamido)-1-methylpyridinium iodide) was used to coat the surface of the metal oxide with a positive charge. As shown in FIG. 5, the CNT/polymer assemblies do not interact with the non-charged surfaces of the wafer.

Referring back to FIG. 4, in step 408, the (functionalized) substrate is then exposed to the solution of CNT/polymer assemblies prepared as described above. By way of example only, the solution of the CNT/polymer assemblies can be deposited onto the substrate, followed by a rinse to remove excess solution. As a result of the interaction of the charged surfaces of the CNT/polymer assemblies with the charged surfaces of the substrate, the CNTs will self-assemble on the surface of the substrate forming a (self-assembled) layer of CNTs or an array of individual CNTs on the substrate. In the example provided above, the CNT/polymer assemblies (bearing a negative surface charge) will self-assemble on the second material (e.g., HfO₂)/NMPI surfaces of the patterned substrate bearing a positive charge forming a CNT layer/array. The final CNT layer/array will include the CNT/polymer assemblies, unless (as described above) the polymer is removed. Any remaining solvent can be removed by drying the substrates with a stream of air or nitrogen.

As highlighted above, the present process can be implemented to form a layer of CNTs or an array of individual CNTs on a substrate. When formed as a layer, the CNTs are not regularly aligned, and overlap and/or contact one another. By contrast, in an array, the CNTs are regularly aligned, and do not overlap or contact one another. An array of individual CNTs may be preferable when devices are being fabricated which require individual CNTs to form the device. For instance, when the device features that are capable of interacting with the CNTs specifically are small enough (in the order of magnitude of about 100 nanometers or less), only one CNT fits inside the feature. After deposition of an array of individual CNTs, regular electrode deposition steps used for CMOS fabrication can be used to obtain transistors of each individual CNT in the array. There are instances in which obtaining an array of those individually placed CNTs would be advantageous, for instance if one wants to fabricate arrays of transistors of individual CNTs. This is interesting for digital logic applications based on CNTs.

Whether a layer of CNTs or an array of individual CNTs is formed on the substrate can be regulated by tailoring the above-described process. For instance, to attain an array of individual CNTs (as opposed to a layer), the substrate surface modifications (described above) can be configured such that the features are small enough that only a fraction of the CNTs interacts. Additionally, the carbon nanotube-polymer assembly dispersion can be diluted (e.g., with additional solvent) to reduce the number of CNTs deposited on a given area of the substrate. These techniques can be employed individually, or in combination with one another.

A process for surface-selective polymer-mediated assembly of CNTs via interactions between (e.g., thiol) functional groups on the polymer and surfaces of a substrate coated with a material configured to interact with the functional groups are described, for example, in U.S. patent application Ser. No. 13/912,417, filed on Jun. 7, 2013, entitled “Surface Modification Using Functional Carbon Nanotubes,” the entire contents of which are incorporated by reference herein.

The present techniques have the following advantages: (1) the binding between the present functionalized polymer and the CNTs is via pi-pi stacking, which is relatively strong—this means that there is no dynamic equilibrium between the polymer molecules on the surface of the CNTs and the free polymer in solution; (2) excess polymer can be removed by washing the polymer/CNT assemblies with excess solvent, which is desirable for CNT deposition purposes, because excess free polymer could result in deposition of just the excess polymer on the charged substrate and not deposition of the CNTs, since both are charged species competing for the charged substrate; (3) excess surfactant is easy to detect, since the polymers are colored and can also be fluorescent as is the case with conjugated polymers such as poly(thiophene)s, which allows for their detection using standard spectroscopic techniques; (4) in order to remove the maximum amount of free polymer possible before CNT deposition, dialysis is not required, since the excess polymer can be easily washed away by filtration; (5) removal of excess surfactant usually does not lead to nanotube aggregation, since the fraction of the polymer directly interacting with the CNT walls is hard to remove using common solvents for washing; (6) high concentrations of CNTs in solution can be achieved without having to use excess polymer, since a thin coating of polymer will be in close contact with the CNT walls and preventing the CNTs from aggregating; (7) since the polymer is strongly bound to the surface of the nanotubes, CNT/polymer dispersions are highly stable over time—this means that the amount of free polymer will not vary over time; (8) the side-chain of the polymer can be fine-tuned and modified to promote different kinds of interactions with different substrates.

The following non-limiting example illustrates the above-described process for functionalizing the surface of a substrate and polymer-mediated assembly of the CNT/polymer assemblies on the functionalized substrate in accordance with the present techniques. In this example, the substrate employed was a patterned substrate of HfO₂ and silicon dioxide SiO₂ (see, for example, FIG. 5, described above). The substrate was exposed to a positively charged pyridinium salt bearing a hydroxamic acid moiety, NMPI (4-(N-hydroxycarboxamido)-1-methylpyridinium iodide), which resulted in the selective coating of the patterned HfO₂ with a positively charged monolayer.

The substrate was then exposed to a solution of the above-described CNT/polymer assemblies for two hours, followed by rinsing with water to remove excess solution, and CNT deposition was confirmed by scanning electron micrograph (SEM). See FIG. 6. As shown in FIG. 6, (metal oxide) HfO₂ areas are completely covered by CNTs, whereas the (non-metal oxide) SiO₂ areas show no CNT deposition. The scale bar at the bottom left of the image equals 10 millimeters. A magnified view of the (CNT-covered) HfO₂ areas of the wafer is shown in FIG. 7 and a magnified view of the SiO₂ areas with no CNT is shown in FIG. 8.

The CNTs were self-assembled only on the monolayer-coated HfO₂ areas of the substrate with very high selectivity, due to the coulombic attraction between the positively charged substrate and the negatively charged CNT/polymer assemblies. The deposition density on HfO₂ was very high as shown in the SEM images, which is desired for self-assembly purposes. See, for example, FIG. 7. FIG. 7 is an SEM image of the HfO₂ area of the substrate. Areas with CNTs have a texture and CNTs are indicated with an arrow. The scale bar at the bottom left of the image equals 1 micrometer. As shown in FIG. 8, no CNTs were deposited on the areas of the substrate where the surface composition is SiO₂. FIG. 8 is a SEM image of the SiO₂ area of the substrate. The scale bar at the bottom left of the image equals 1 micrometer. All of the SEM images were taken at 1 kilovolt.

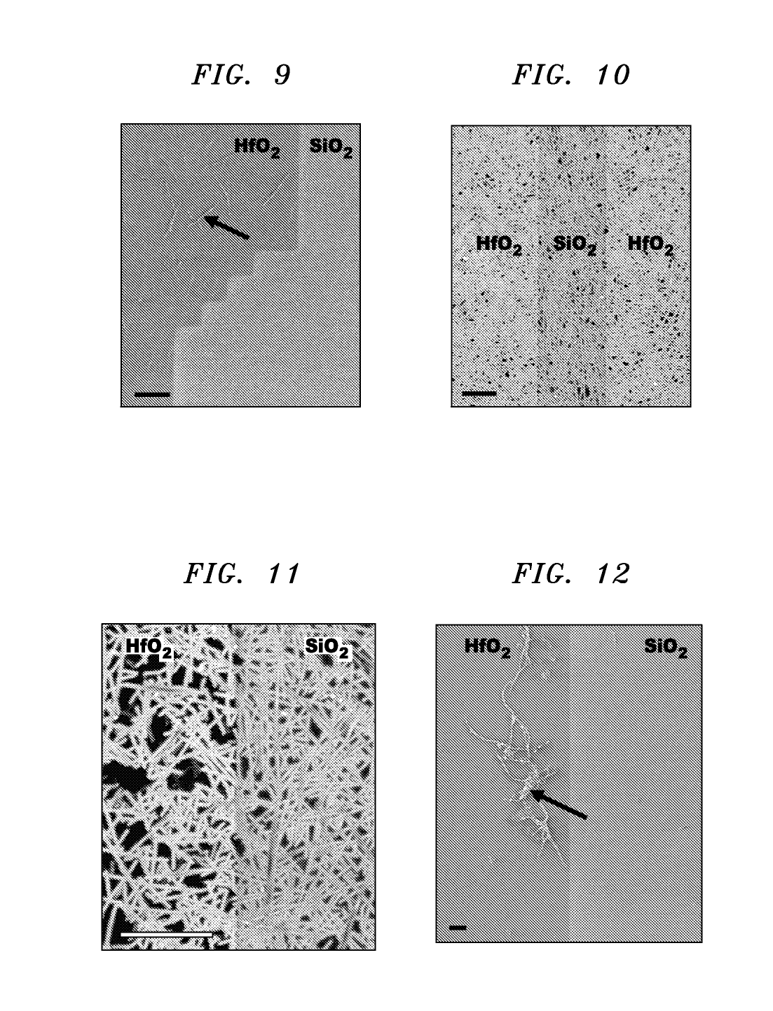

When substrates that had not been covered with a positively charged monolayer were exposed to the solution of CNT/polymer assemblies, the CNTs were selectively deposited on the HfO₂ as observed by SEM, but the density was comparatively low, as shown in FIG. 9, and the CNTs could be detached by sonication. This is due to the fact that phosphonates are weaker ligands for HfO₂ than hydroxamic acids. FIG. 9 is an SEM image showing the deposition of the present CNT/polymer assemblies on HfO₂/SiO₂ patterned substrates where no monolayer treatment has been applied. CNTs are indicated with an arrow. The scale bar at the bottom left of the image equals 2 micrometers.

When poly(3-hexylthiophene) (P3HT) was used instead of regioregular polythiophene polymers with charged phosphonate side-chains for the directed self-assembly of CNTs, then no selectivity was observed (see FIG. 10), which highlights the importance of the specific functional group in the side-chain of the polymer. FIG. 10 is an SEM image showing the deposition of CNT/P3HT on HfO₂/SiO₂ patterned substrates. As shown in FIG. 10, no selective CNT placement is observed. The scale bar at the bottom left of the image equals 200 nanometers.

The effect of the degree of functionalization in the polymer side chain was also studied for the present functionalized polymers. Copolymers with 5% of phosphonic acid in the side-chain (polymer 312, 100*b/(a+b)=5) were only soluble in organic solvents such as CHCl₃, and copolymers with 50% phosphonic acid in the side-chain were only slightly soluble in water in their deprotonated form (polymer 302, 100*b/(a+b)=50).

Directed Self-Assembly of CNTs was tested using polymers containing 5% phosphonate side-chains on the HfO₂/SiO₂ substrates where the HfO₂ was coated with a positively charged monolayer, which resulted in non-selective placement of the CNTs. See FIG. 11. FIG. 11 is an SEM image showing the deposition of the present CNT/polymer assemblies 202 on HfO₂/SiO₂ patterned substrates, where the polymer has a 5% content of phosphonic acid in the side-chain. As shown in FIG. 11, no selective CNT placement is observed (i.e., CNTs are present on both the HfO₂ and SiO₂ surfaces. The scale bar at the bottom left of the image equals 1 micrometer. This non-selective placement is probably due to the fact that such a low content of phosphonic acid functional groups is not enough to direct the self-assembly of the CNTs, since most of the CNT wall will be coated with hydrophobic groups.

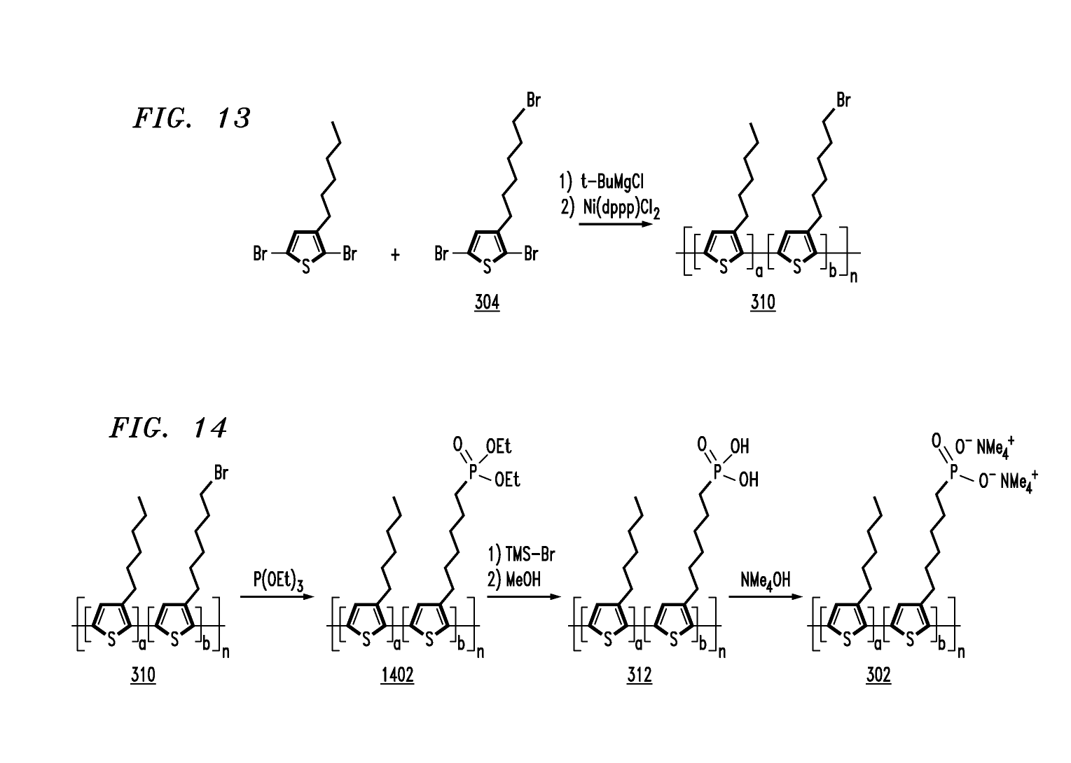

On the other hand, when copolymers that contained 50% of phosphonate substitution in the side-chain were used for the directed self-assembly of CNTs from water, selective placement was observed on the HfO₂/SiO₂ substrates. However, the CNTs were aggregated and the placement density was very low as shown in FIG. 12. FIG. 12 is an SEM image showing the deposition of the present CNT/polymer assemblies 202 on HfO₂/SiO₂ patterned substrates, where the polymer has 50% content of phosphonic acids in the side-chain. As shown in FIG. 12, selective placement was achieved, but the CNT density was very low and the CNTs were aggregated in bundles. The scale bar at the bottom left of the image equals 1 micrometer. The fact that the polymer had only 50% of hydrophilic side-chains probably caused hydrophobic micro-domains to form, which will interact with each other and not with the solvent or the substrate, leading to CNT aggregation. This is not the case when using polymers with 100% phosphonate groups in the side-chain (e.g., polymer 202), where the CNT/polymer solution was completely stable over time and no CNT aggregation was observed. This is due to the fact that the CNT surface is completely decorated with negative charges from the polymer wrapping it, which makes the CNT completely water-soluble and prevents aggregation. It is evident from these experiments that variations in the degree of polymer side-chain substitution can affect CNT solubility and the dynamics of CNT aggregation in different solvents, as well as the deposition process and its selectivity. Therefore, according to an exemplary embodiment, the (e.g., regioregular polythiophene with charged phosphonate side chains) polymers have preferably from about 50% to about 100% of phosphonic acid in their side chains.

The present techniques are further illustrated by way of reference to the following non-limiting example:

Instruments: NMR spectra were obtained on a Bruker Avance (400 MHz). NMR chemical shifts are given in parts per million (ppm) referenced to CHCl₃/tetramethylsilane (TMS) (7.24 ppm for ¹H). Polymer molecular weights were determined at room temperature on a Waters 2695 GPC system in tetrahydrofuran (THF) at 1.0 mL/min (1 mg/mL sample concentrations), approximate molecular weights were estimated using a polystyrene calibration standard. Scanning Electron Microscopy (SEM) images were obtained using a LEO 1560 at 1 keV, 20 μm aperture. Substrates were cleaned with a plasma cleaner from Harrick Plasma, model PDC-32G. MiliQ water was obtained using a Q-Pod from Milipore. The probe sonicator used for these experiments was a SONICS from Vibra Cell. CNT bundles were removed by centrifugation using an IEC Centra CL2.

Self-Assembly of CNT/polymer 1 from water: For the deposition of CNTs wrapped in the polymer (regioregular polythiophene with charged phosphonate side-chains), 3 milligrams of the phosphonic acid version of the polymer were dispersed in 10 milliliter miliQ water, to which 5 milligrams of tetramethylammonium hydroxide pentahydrate were added. The polymer was sonicated until completely dissolved, and 2 milligrams of CNTs were added. The resulting mixture was sonicated using a probe sonicator for 45 minutes. The CNT dispersion was centrifuged for 30 minutes to remove CNT bundles and the supernatant was filtered through a cellulose acetate filter (0.22 micrometer (μm) pore size). The filter was washed with 100 milliliters of miliQ water to remove excess polymer and tetramethylammonium hydroxide and the residue was resonicated into 10 milliliters of miliQ water with a bath sonicator. The CNT dispersion was sonicated using a probe sonicator for 45 minutes, followed by centrifugation for 30 minutes to remove CNT bundles. The resulting supernatant was used for the directed self-assembly of the CNTs. Patterned substrates of HfO₂ on SiO₂ were plasma cleaned for 5 minutes and dipped in a 100/1 HF/H₂O solution followed by thorough rinsing with water and drying under nitrogen. The HfO₂ parts of the substrate were selectively coated with a monolayer of positively charged molecules (NMPI) by immersion for 2 hours in an NMPI solution (24 milligrams of NMPI in 9 milliliters EtOH, 3 milliliters H₂O), followed by rinsing with water. Exposure of these substrates to the CNT/polymer solution for 2 hours led to the self assembly of thin films of CNTs with very high density and selectivity in the HfO₂ parts of the substrate.

Polymer Synthesis: Unless otherwise noted, all reactions were performed in oven-dried glassware, and under an oxygen-free atmosphere of nitrogen. Polymerizations were carried out using standard Schlenk techniques. Anhydrous solvents and all other chemicals were obtained from Sigma-Aldrich and were used as received. 2,5-dibromo-3-(6-bromohexyl)thiophene2 and NMPI1 were synthesized as previously described in the literature. CNTs (ASP) were obtained from Hanwha Nanotech and used as received.

General procedure for the synthesis of poly(thiophene)s with alkylbromide side-chains: An exemplary process for the synthesis of poly(thiophene)s with alkylbromide side-chains is shown in FIG. 13. In this example, regioregular poly(thiophene)s with different degrees of side-chain substitution were synthesized from the corresponding 2,5-dibromo-3-hexylthiophene and 2,5-dibromo-3-(6-bromohexyl)thiophene 304. To a solution of the appropriate feed ratio of functionalized 304 and unfunctionalized monomer (1 eq) in dry THF was added t-BuMgCl (1.0 M in THF, 1 eq) at room temperature. The reaction mixture was then heated to 70° C., and after stirring for 2 hours, NidpppCl2 (1.4 mol %) dispersed in 1 milliliter dry THF was added via cannula. The reaction was observed to immediately turn deep orange and fluorescent yellow. After stirring for 12 hours, the resulting polymer was precipitated from methanol. The resulting dark purple solid was re-dissolved in CHCl₃ and re-precipitated in MeOH and dried under vacuum. The resulting polymer contained the same ratio of functionalized to unfunctionalized repeat units as the initial feed ratio of the two different monomers, as confirmed by 1H-NMR.

For the random copolymer of poly(3-hexylthiophene) and poly(3-(6-bromohexylthiophene)) 310 (a=95%, b=5%), 85% yield. Mn=22K, PDI=1.3, 1H-NMR (CDCl3, ppm): 0.80-1.20 (bt, 3H), 1.20-1.60 (bm. 4.2H), 1.82 (bt, 2.1H), 1.90 (bt, 0.1H), 2.81 (t, 2.1H), 3.41 (bt, 0.1H), 6.96 (bs, 1.1H).

For the random copolymer of poly(3-hexylthiophene) and poly(3-(6-bromohexylthiophene)) 310 (a=50%, b=50%), 85% yield. Mn=23K, PDI=1.3, 1H-NMR (CDCl3, ppm): 0.80-1.20 (bt. 3H), 1.20-1.60 (bm. 10H), 1.82 (bt, 4H), 1.90 (bt, 2H), 2.81 (t, 4H), 3.41 (bt, 2H), 6.96 (bs, 2H).

General procedure for polymer side-chain modification to obtain phosphonated polythiophenes: An exemplary process for polymer side-chain modification to obtain phosphonated polythiophenes is shown in FIG. 14. In this example, 20 milligrams of the desired polymer were dissolved in 5 milliliters of triethylphosphite and heated to 160° C. in a pressure vessel under a nitrogen atmosphere. After 5 hours, the reaction was taken back to room temperature, and the excess triethylphosphite was removed by distillation under vacuum. The resulting residue was taken up in chloroform, and precipitated by addition to an excess of methanol. This procedure was repeated twice to obtain the desired polymer with a phosphonate ester in the side-chains.

For the precursor of polymer 202, 1402 (a=0, b=n), 95% yield. Mn=25K, PDI=1.3, 1H-NMR (CDCl3, ppm): 1.3-1.8 (bm, 16H), 2.5 (bt, 2H), 4.1 (bm, 4H), 6.95 (bs, 1H). This polymer with diethylphosphonate side-chains was dissolved in 3 milliliters of dichloromethane and TMS-Br was added drop-wise. The reaction was stirred at room temperature overnight, after which volatiles were removed under vacuum. The resulting polymer was sonicated in 3 milliliters of methanol and stirred at room temperature for 4 hours, after which volatiles were once again removed under vacuum. The resulting polymer with phosphonic acids in all side-chains 312 was insoluble in water and organic solvents but could be taken into aqueous solutions of tetramethylammonium hydroxide to yield polymer 202.

Although illustrative embodiments of the present invention have been described herein, it is to be understood that the invention is not limited to those precise embodiments, and that various other changes and modifications may be made by one skilled in the art without departing from the scope of the invention.

1. A method for self-assembly of carbon nanotubes on a substrate, the method comprising the steps of:
creating a charge on one or more surfaces of the substrate; and
contacting the substrate with carbon nanotube-polymer assemblies dispersed in a solvent, wherein the carbon nanotube-polymer assemblies comprise the carbon nanotubes wrapped in a polymer having side chains with charged functional groups, and
wherein by way of the step of contacting the substrate with the carbon nanotube-polymer assemblies, the carbon nanotube-polymer assemblies selectively bind to the charged surfaces of the substrate based on complementary electrostatic interactions between the charged functional groups on the polymer and the charged surfaces of the substrate and thereby self-assemble on the substrate.

2. The method of claim 1, wherein the polymer comprises a regioregular polythiophene with charged phosphonate side chains.

3. The method of claim 1, wherein the polymer wraps around the carbon nanotubes via pi-pi stacking.

4. The method of claim 1, further comprising the steps of:
dispersing the polymer in the solvent to form a polymer dispersion; and
adding the carbon nanotubes to the polymer dispersion, and
wherein by way of the step of adding the carbon nanotubes to the polymer dispersion, the polymer interacts with the carbon nanotubes to form the carbon nanotube-polymer assemblies dispersed in the solvent.

5. The method of claim 1, wherein the solvent is selected from the group consisting of: water ethanol, isopropanol, and dimethylsulfoxide.

6. The method of claim 1, wherein the step of creating the charge on the one or more surfaces of the substrate comprises the step of:
selectively coating the surfaces of the substrate with a monolayer of positively charged molecules.

7. The method of claim 1, wherein the step of creating the charge on the one or more surfaces of the substrate comprises the step of:
coating an entire surface of the substrate with a monolayer of positively charged molecules.

8. The method of claim 1, wherein the substrate comprises at least one first region comprising at least one first material and at least one second region comprising at least one second material, and wherein the step of creating the charge on the one or more surfaces of the substrate comprises the step of:
contacting the substrate with a compound comprising a positively charged pyridinium salt bearing a hydroxamic acid moiety, wherein the first material has an isoelectric point that is less than a pKa of hydroxamic acid and the second material has an isoelectric point that is greater than the pKa of hydroxamic acid, and wherein by way of the step of contacting the substrate with the compound, the compound interacts with the second material of the substrate to form a monolayer of positively charged molecules on a surface of the second region of the substrate.

9. The method of claim 8, wherein the first material comprises silicon dioxide.

10. The method of claim 8, wherein the second material is selected from the group consisting of: silicon nitride, hafnium oxide, and aluminum oxide.

11. The method of claim 1, wherein the substrate comprises at least one first region comprising at least one first material and at least one second region comprising at least one second material, and wherein the step of creating the charge on the one or more surfaces of the substrate comprises the step of:
contacting the substrate with a compound comprising a positively charged pyridinium salt bearing a phosphonic acid moiety, wherein the first material has an isoelectric point that is less than a pKa of phosphonic acid and the second material has an isoelectric point that is greater than the pKa of phosphonic acid, and wherein by way of the step of contacting the substrate with the compound, the compound interacts with the second material of the substrate to form a monolayer of positively charged molecules on a surface of the second region of the substrate.

12. The method of claim 2, wherein the polymer comprises from about 50% to about 100% of phosphonic acid in the side chains.

13. The method of claim 1, further comprising the step of:
annealing the carbon nanotube-polymer assemblies once self-assembled on the substrate to remove the polymer.

14. The method of claim 1, wherein by way of the step of contacting the substrate with the carbon nanotube-polymer assemblies, the carbon nanotube-polymer assemblies self-assemble on the substrate to form a layer of the carbon nanotubes on the substrate.

15. The method of claim 1, wherein by way of the step of contacting the substrate with the carbon nanotube-polymer assemblies, the carbon nanotube-polymer assemblies self-assemble on the substrate to form an array of individual carbon nanotubes on the substrate.

16-24. (canceled)
